(19) United States
(12) Patent Application Publication
(10) Pub. No.: US 2025/0316994 A1
(43) Pub. Date: Oct. 9, 2025

(54) ELECTRICAL SYSTEM

(71) Applicant: Lear Corporation, Southfield, MI (US)

(72) Inventors: Carlos Manuel Pérez Ruiz, Valls (ES); Marc Deumal Herraiz, L'Argilaga (ES); Rachid El Ghouchma, Rabat (MA); Josep Vallverdu Guasch, Valls (ES); Josep Jacas Miret, Valls (ES); Carles Vilella Parra, Valls (ES)

(73) Assignee: Lear Corporation, Southfield, MI (US)

(21) Appl. No.: 19/089,500

(22) Filed: Mar. 25, 2025

Related U.S. Application Data
(60) Provisional application No. 63/575,334, filed on Apr. 5, 2024.

(51) Int. Cl. H02J 7/00; B60L 3/00

(52) U.S. Cl. CPC H02J 7/0031; B60L 3/0061; H02J 7/0047; H02J 7/007; B60L 2240/42; H02J 2207/10

(57) ABSTRACT

An electrical system, comprising an electronic controller; and an active discharge system configured to discharge an electrical load having a capacitance, the active discharge system including: an active discharge resistor; a switch assembly electrically connected to the active discharge resistor, the switch assembly including an active discharge switch; a signal generator; and a logic circuit electrically connected to the switch assembly and the signal generator, the logic circuit including one or more diodes; wherein the logic circuit is configured to selectively electrically connect the electronic controller or the signal generator to the switch assembly.

### CROSS-REFERENCE TO RELATED APPLICATIONS

This application claims the benefit of and priority to U.S. Provisional Application 63/575,334 filed Apr. 5, 2024, the disclosure of which is hereby incorporated by reference in its entirety as though fully set forth herein.

### TECHNICAL FIELD

The present disclosure generally relates to electrical systems, including electrical systems that can, for example, be utilized in connection with vehicles, such as electric vehicles.

### BRIEF DESCRIPTION OF THE DRAWINGS

While the claims are not limited to a specific illustration, an appreciation of various aspects may be gained through a discussion of various examples. The drawings are not necessarily to scale, and certain features may be exaggerated or hidden to better illustrate and explain an innovative aspect of an example. Further, the exemplary illustrations described herein are not exhaustive or otherwise limiting, and embodiments are not restricted to the precise form and configuration shown in the drawings or disclosed in the following detailed description. Exemplary illustrations are described in detail by referring to the drawings as follows:

FIG. 1 is a schematic view generally illustrating an embodiment of a vehicle and an electrical system according to teachings of the present disclosure.

FIG. 2 is a schematic view generally illustrating an embodiment of an electrical system according to teachings of the present disclosure.

FIG. 3 is a schematic view generally illustrating an embodiment of an electrical system according to teachings of the present disclosure.

FIG. 4 is a schematic view generally illustrating portions of an embodiment of an electrical system, including a signal generator, according to teachings of the present disclosure.

FIG. 5 is a schematic view generally illustrating portions of an embodiment of an electrical system, including a logic circuit, according to teachings of the present disclosure.

FIG. 6 is a flow diagram generally illustrating portions of an embodiment of a method of operating an electrical system according to teachings of the present disclosure.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

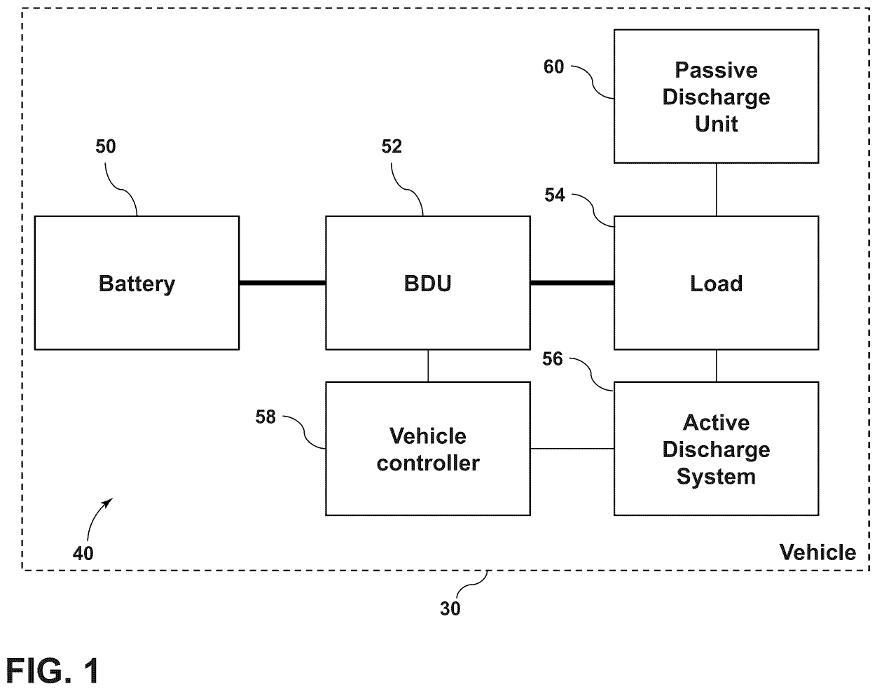

Referring to FIG. 1, a vehicle 30 is illustrated with an electrical system 40 including a battery 50, a battery disconnect unit (BDU) 52 connected to the battery 50, a load 54 (e.g., an electrical load) connected to the BDU 52, an active discharge system 56 connected to the load 54, a vehicle controller 58 connected to the BDU 52 and the active discharge system 56, and a passive discharge unit 60. While the active discharge system 56 and the passive discharge unit 60 are shown separate from each other and the BDU 52 for illustrative purposes, the active discharge system 56 and/or the passive discharge unit 60 can be incorporated with the BDU 52. The vehicle controller 58 controls the BDU 52 to selectively provide power from the battery 50 to the load 54. While the BDU 52 is shown as directly connected to the load 54, one or more other components can be connected therebetween, such as an inverter. The load 54 includes one or more electrical components that, at least collectively, have a capacitance and store a charge when connected to the battery 50. The capacitance can, for example, be at least 1 mF, at least 5 mF, or other values. The load 54 may or may not include a capacitor, but may function as a capacitor, at least to some extent. In some examples, the load 54 comprises an electric traction motor that drives the vehicle 30. When the load 54 is disconnected from the battery 50, it may be desirable to discharge the charge of the load 54. The passive discharge unit 60 is configured to discharge the load 54 over a first period of time. The active discharge system 56 is configured to discharge the load 54 over a second period of time that is shorter than the first period of time. Discharging the load 54 quickly (e.g., in 5 second or less, 1 second or less, 0.5 seconds or less, among other times) may be desirable, at least in some circumstances, such as to prevent unintended discharge.

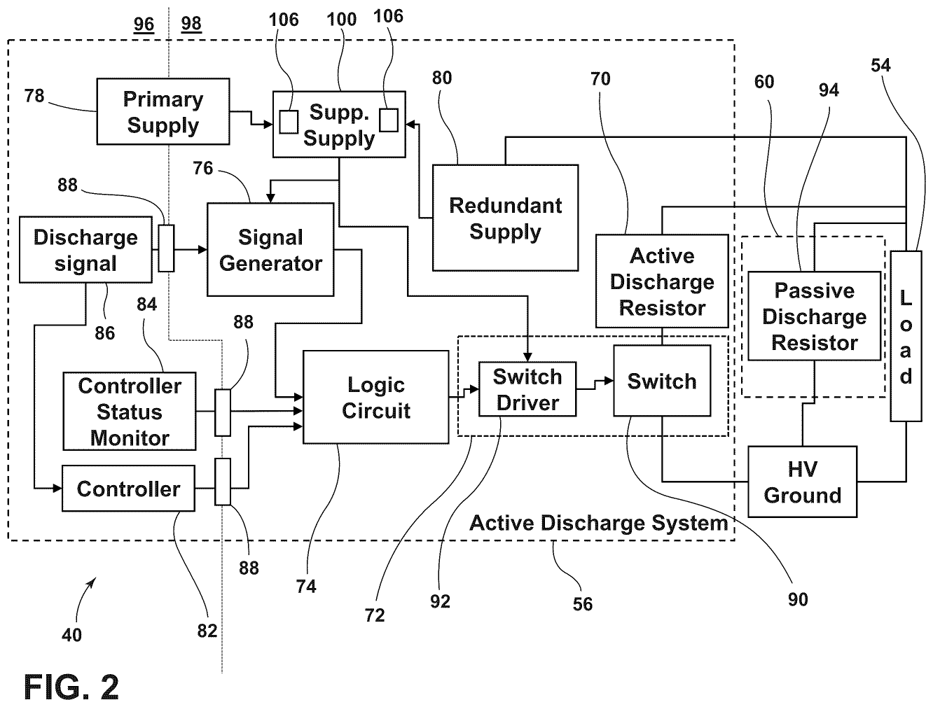

Referring to FIG. 2, the active discharge system 56 includes an active discharge resistor 70, a switch assembly 72, a logic circuit 74, a signal generator 76, a primary power supply 78, a redundant power supply 80, an electronic controller 82, a controller status monitor 84, a discharge signal input 86, and one or more isolators 88. The switch assembly 72 includes a switch 90 (e.g., an active discharge switch) and a switch driver 92 (e.g., a gate driver) connected to control activation of the switch 90. The switch 90 can, for example, have a voltage rating of at least 1000 V, at least 1200 V, or other values. The active discharge resistor 70 is connected to the switch 90 in series. The active discharge resistor 70 and the switch 90 are connected to the load 54 in parallel with the passive discharge unit 60. The passive discharge unit 60 includes a passive discharge resistor 94. The passive discharge resistor 94 has a higher resistance than the active discharge resistor 70 and can discharge the load 54 at all times. A ratio of the resistance of the passive discharge resistor 94 to the resistance of the active discharge resistor 70 can, for example, be at least 100:1, at least 500:1, at least 1000:1, or other values. The active discharge resistor 70 discharges the load 54 when the active discharge system 56 is active with the switch 90 is closed. When the active discharge system 56 is active, both the active discharge resistor 70 and the passive discharge resistor 94 discharge the load 54. In some examples, the electronic controller 82 can be at least partially integrated with the vehicle controller 58 (FIG. 1). For example, the vehicle controller 58 (FIG. 1) can operate as the electronic controller 82. In other examples, the electronic controller 82 can be separate from and in communication with the vehicle controller 58.

The discharge signal input 86 is connected to the signal generator 76 and the electronic controller 82, such as via one or more isolators 88. Outputs of the electronic controller 82, the controller status monitor 84, and the signal generator 76 are connected as inputs to the logic circuit 74. The logic circuit 74 provides either the output from the electronic controller 82 (e.g., a first signal) or the output from the signal generator 76 (e.g., a second signal) to the switch assembly 72, such as in response to the electronic controller 82 receiving the discharge signal from the discharge signal input 86 and/or the signal generator 76 detecting a loss of power. The vehicle controller 58 (FIG. 1) may provide the discharge signal to the discharge signal input 86, which can include providing the discharge signal directly to the electronic controller 82 via a controller area network (CAN) command. Optionally, the vehicle controller 58 provides the discharge signal in accordance with detecting an active discharge condition, such as an imminent or actual vehicle collision or a maintenance activity, among others. The primary power supply 78 and the redundant power supply 80 are connected to the signal generator 76 and the switch driver 92. Optionally, the primary power supply 78 and the redundant power supply 80 are connected in parallel to provide a supplemented power supply 100 that is connected to the signal generator 76 and the switch driver 92. The supplemented power supply 100 can be configured such that power is output when either or both of the primary power supply 78 and the redundant power supply 80 are active (e.g., the supplemented power supply 100 can function as an OR gate). The supplemented power supply 100 can include diodes 106 connected to outputs of the primary power supply 78 and the redundant power supply 80.

The one or more isolators 88 isolate a low voltage (LV) portion or domain 96 of the electrical system 40 from a high voltage (HV) portion or domain 98 of the electrical system 40. In the illustrated example, a portion of the primary power supply 78, the controller 82, and/or the controller status monitor 84 are in the LV domain, and the load 54, the passive discharge unit 60, the active discharge resistor 70, the switch assembly 72, the signal generator 76, the redundant power supply 80, and/or the supplemented power supply 100 are in the HV domain 98. For example, part of the active discharge system 56 is in the LV domain 96 and isolated from a part of the active discharge system that is in the HV domain 98.

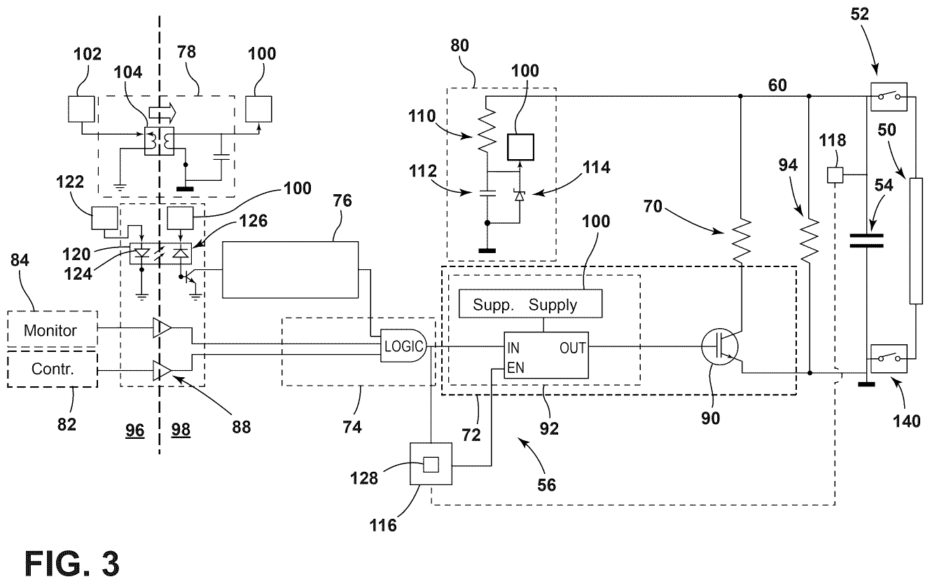

Referring to FIG. 3, the primary power supply 78 provides an isolated power supply from a power source 102 that may be at a low voltage, such as in a range of 10 V to 20 V (e.g., a 12 V battery). The isolation is provided by a transformer 104, but can be provided via additional or alternative methods. The output of the primary power supply 78 is electrically connected to the supplemented power supply 100. The redundant power supply 80 is connected to the battery 50 (e.g., a high voltage battery), and includes a resistor 110 connected in series with a capacitor 112 and a Zener diode 114 connected in parallel, which can function as a voltage divider. The output of the redundant power supply 80 is electrically connected to the supplemented power supply 100.

The signal generator 76 is connected to or includes an isolator 120 of the one or more isolators 88. The isolator 120 is connected to a second power source 122, which can include a switched connection the power source 102. For example, with vehicle applications, the second power source 122 can be active when the vehicle is active (e.g., a “vehicle on”, “key on”, or “ignition on” state). Optionally, the isolator 120 includes a diode (e.g., a light emitting diode (LED)) 124 and a light sensor 126, which optionally includes a photo transistor, a photo diode, a transistor and a photo diode, other components, or combinations thereof). The diode 124 is disposed in the LV domain 96. The light sensor 126 is disposed in the HV domain. The LED 124 is connected to second power source 122 and emits light when the second power source 122 is active. The light sensor 126 is connected to the supplemented power supply 100 and opens and closes according to the light or lack of light emitted by the LED 124. In some configurations, the light sensor 126 closes when the LED 124 is emitting light (e.g., the second power source 122 is active). In other configurations, the switch 126 closes when the LED is not emitting light.

Optionally, the active discharge system 56 includes a disable circuit 116 and a sensor 118 (e.g., a voltage sensor). The disable circuit 116 is electrically connected to the output of the logic circuit 74 and to an input of the switch driver 92. The disable circuit 116 includes a timer 128. A timeout period of the timer 128 is, for example, lower than a signal generator duration of the signal generator 76. In an initial state, the disable circuit 116 provides a logical high output to the switch driver 92. In accordance with the logic circuit 74 activating the switch assembly 72, such as via the switch driver 92, the timer 128 is activated and the disable circuit 116 monitors a voltage of the load 54, such as via the sensor 118. The sensor 118 is provided to obtain a load voltage of the load 54. In accordance with the voltage of the load 54 not decreasing by a threshold voltage before expiration of the timer 128, the disable circuit 116 provides a logical low output to the switch driver 92, disabling the active discharge process. Such a configuration is, for example, operable to detect a fault in the active discharge process and disable the active discharge process in the event of such a fault. In accordance with the voltage of the load 54 decreasing by at least the threshold voltage before expiration of the timer 128, the disable circuit 116 continues to provide the logical high output to the switch driver 92. The timer 128 optionally resets automatically, such as for as long as the logic circuit 74 is active. For example, the disable circuit 116 is operable to continuously monitor active discharge of the load 54. Optionally, the disable circuit 116 is devoid of a controller. Alternatively, the disable circuit 116 includes a disable controller.

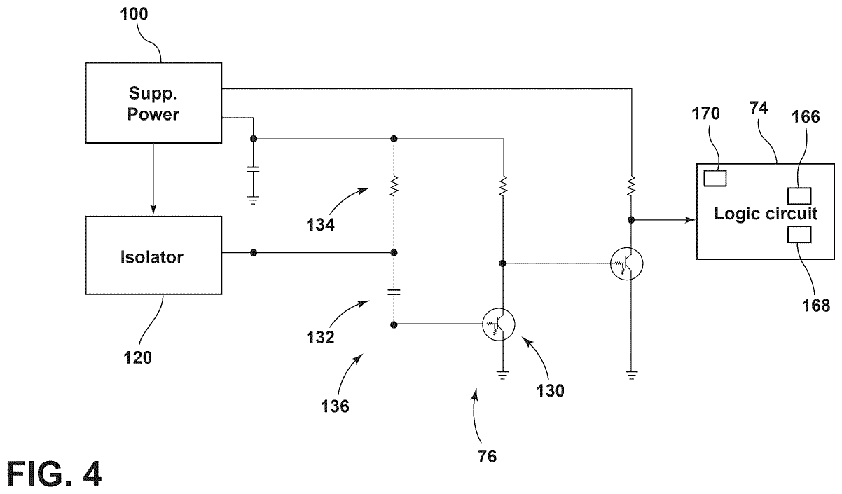

The signal generator 76 can include one or more of a variety of configurations. In the example illustrated in FIG. 4, the signal generator 76 includes one or more signal generator switches 130, a capacitor 132, and a plurality of resistors 134. Optionally, at least one of the plurality of resistors 134 can be connected with the capacitor 132 to provide a resistor-capacitor (RC) circuit 136 (e.g., an RC timer). The RC circuit 136 can be configured such that the signal generator 76 generates the second signal (e.g., pulse) having a signal generator duration that corresponds to an expected discharge time of the load 54, which can include the signal generator duration being sufficiently long to discharge the load 54 (FIG. 3) via the active discharge resistor 70 (FIG. 3), at least to a threshold charge level, which can 0 V or above 0 V (e.g., 60 V). For example, the capacitor 132 may hold the signal generator switch 130 closed after the second power source 122 becomes inactive until the capacitor 132 is discharged via the at least one of the resistors 134, and the discharge time of the capacitor 132 can be configured to match or exceed the discharge time of the load 54 via the active discharge resistor 70. The output of the signal generator 76 is connected to the logic circuit 74. The timeout period of the timer 128 (FIG. 3) is, for example, shorter than the signal generator duration and/or the discharge time of the load 54.

The controller status monitor 84 (FIGS. 2, 3, 5) outputs a status signal (e.g., a health signal) that indicates whether the electronic controller 82 is active (e.g., a high signal when active and a low signal when not active). The controller status monitor 84 can include one or more of a variety of configurations. In some examples, the controller status monitor 84 comprises a system basis chip (SBC) in communication with and/or electrically connected with the electronic controller 82. Additionally or alternatively, in some examples, the controller status monitor 84 comprises a sensor (e.g., voltage sensor) configured to sense one or more characteristics (e.g., input voltage, output voltage, temperature, chip frequency, among others) of the electronic controller 82.

Referring again to the example illustrated in FIG. 3, the BDU 52 includes one or more switches, such as one or more contactors 140. The contactors 140 selectively electrically connect the battery 50 with the load 54, the active discharge system 56, and the passive discharge unit 60. The contactors 140 can, for example, be controlled by the vehicle controller 58 (FIG. 1). Optionally, the BDU 52 includes the active discharge system 56 and/or components thereof, such as the electronic controller 82. While the electronic controller 82 is shown as part of the active discharge system 56, the electronic controller 82 can be separate from and in communication with the active discharge system 56.

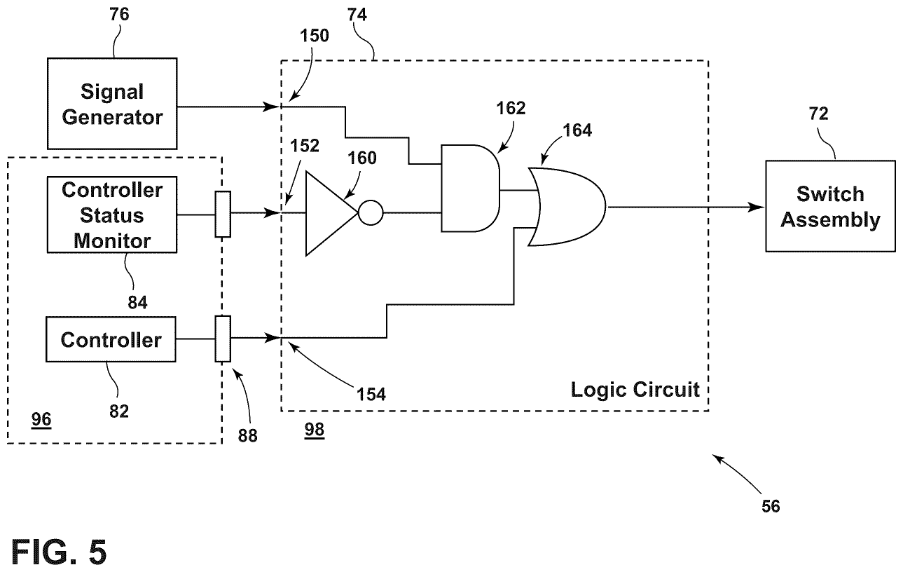

Referring to FIG. 5, an example of the logic circuit 74 of the active discharge system 56 is illustrated. The first input 150 of the logic circuit 74 is connected to the signal generator 76, a second input 152 of the logic circuit 74 is connected to the electronic controller 82, and a third input 154 of the logic circuit 74 is connected to the controller status monitor 84. In the illustrated example, the logic circuit 74 includes a NOT gate 160, an AND gate 162, and an OR gate 164. The input of the NOT gate 160 is electrically connected to the controller status monitor 84, such as via the one or more isolators 88. The output of the NOT gate 160 is electrically connected to a first input of the AND gate 162. The output of the signal generator 76 is electrically connected to a second input of the AND gate 162. The output of the AND gate 162 is electrically connected to a first input of the OR gate 164. The output of the electronic controller 82 is electrically connected to a second input of the OR gate 164, such as via the one or more isolators 88. With such a configuration of the gates 160, 162, 164, the logic circuit 74 provides the first signal from the electronic controller 82 to the switch assembly 72 to activate the active discharge system 56 when the electronic controller 82 is active, the controller status monitor 84 indicates that the electronic controller 82 is active, and the electronic controller 82 receives the discharge signal, such as from the discharge signal input 86 (FIG. 2). For example, the first signal from the electronic controller 82 is passed by the OR gate 164 to the switch assembly 72, and the status signal is high, so the NOT gate 160 inverts the status signal to low, resulting in the output of the AND gate 162 being low (e.g., 0). In response to the controller status monitor 84 indicating that the electronic controller 82 is inactive, the status signal from the controller status monitor 84 is low and the NOT gate 160 inverts the status signal to high. The second signal from the signal generator 76 is also high, so the AND gate passes the second signal, or a variation of the second signal, to the OR gate 164, which passes the second signal to the switch assembly 72 to activate the active discharge system 56. The logic circuit 74 and/or the gates 160-164 can, for example, include and/or be implemented via diodes 166, switches 168 (e.g., transistors), resistors 170, other components, or combinations thereof (FIG. 4).

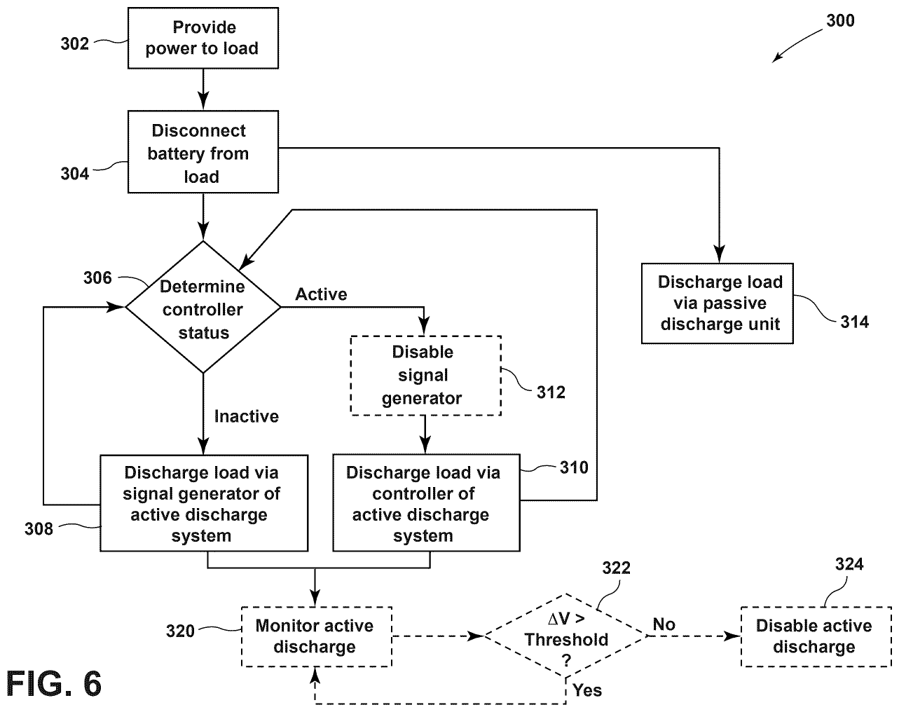

Referring to FIG. 6, a method 300 of operating the electrical system 40 includes providing electrical power to the load 54 (block 302), such as from the battery 50. Providing power to the load 54 can include charging the load 54, which can have a capacitance. The method 300 includes disconnecting the battery 50 from the load 54 (block 304). The method 300 includes determining a status (e.g., active or inactive) of the electronic controller 82 (block 306), such as via the controller status monitor 84. The method 300 includes discharging the load 54 via the active discharge system 56 (blocks 308, 310).

If the electronic controller 82 is active, discharging the load 54 via the active discharge system 56 can include, at block 310, the electronic controller 82 activating the switch assembly 72 (e.g., via the OR gate 164) to discharge the load 54 through the active discharge resistor 70, such as when the electronic controller 82 is active and/or the second power source 122 is active. If the electronic controller 82 is inactive, discharging the load 54 via the active discharge system 56 can also include, at block 310, the signal generator 76 activating the switch assembly 72 (e.g., via the gates 160-164) to discharge the load 54 through the active discharge resistor 70, such as when the electronic controller 82 is inactive and/or the second power source 122 is inactive. The signal generator 76 can automatically activate the switch assembly 72 to discharge the load 54, independently of (e.g., without input or instruction from) the electronic controller 82 and, in at least some examples, entirely without software. For example, the signal generator 76 can automatically activate the switch assembly 72 to discharge the load 54 when the primary power supply 78, the power source 102, and/or the second power source 122 are or become inactive. The signal generator 76 activating the switch assembly 72 can include utilizing power from the redundant power supply 80, such as if the primary power supply 78 is inactive (e.g., if the power source 102 is inactive). For example, the active discharge system 56 can operate to discharge the load 54 even when some or all of the primary power supply 78, the power source 102, the second power source 122, and the electronic controller 82 are inactive. The active discharge system 56 does not require operation of a controller, such as the vehicle controller 58 or the electronic controller 82, to discharge the load 54.

In some examples, blocks 308 and 310 can include discharging the load 54 by at least 700 V via the active discharge system 56 in less than one second. For example and without limitation, the active discharge system 56 can be configured to discharge the load 54, which can include a capacitance of at least 5 mF, from 820 V to less than 60 V in less than 0.5 seconds.

Optionally, the method 300 includes disabling the signal generator 76 (block 312), such as via the logic circuit 74 if the status of the electronic controller 82 changes from inactive to active while the signal generator 76 is activating the switch assembly 72. For example, disabling the signal generator 76 can include the output of the AND gate 162 becoming low or zero in response to the output of the NOT gate 160 becoming low or zero in response to the status signal becoming high, preventing the logic circuit 74 from outputting the second signal from the signal generator 76.

The method 300 includes discharging the load 54 via the passive discharge unit 60 (block 314). Discharging the load 54 via the passive discharge unit 60 can occur at all times the battery is disconnected from the load 54, such as during some or all of blocks 304-310. Optionally, passive discharging of the load 54 in block 314 is conducted even when the battery 50 is not disconnected from the load 54.

Optionally, the method 300 includes monitoring the active discharge process (block 320), such as via the disable circuit 116. For example, the disable circuit 116 can monitor the voltage of the load 54 via the sensor 118. In block 322, the disable circuit 116 can compare the voltage of the load 54 to the threshold after the period of time, and determine if the change in voltage is at least as great as the threshold. In accordance with the change in voltage being less than the threshold, the method 300 includes disabling the active discharge process (block 324), such as via the disable circuit 116 disabling the switch driver 92 and/or via disabling the signal generator 76 (block 312). In accordance with the change in voltage being at least as great as the threshold, the method 300 includes continuing with the active discharge process in block 308 or 310 and/or continuing to monitor the active discharge process in block 320.

While described in connection with a vehicle for illustrative purposes, the instant disclosure is not limited to vehicle applications.

Switches described herein can include one or more of a variety of configurations. For example, switches can include transistors (e.g., bipolar junction transistors (BJTs), field effect transistors (FETs), others), relays, contactors, other components, or combinations thereof.

Electric systems disclosed herein can discharge loads more efficiently, more quickly, more effectively, and/or with a broader range of operating conditions (e.g., power source/supply and controller availability) than other designs.

The instant disclosure includes the following non-limiting embodiments:

An electrical system, comprising: an electronic controller; and an active discharge system configured to discharge an electrical load having a capacitance, the active discharge system including: an active discharge resistor; a switch assembly electrically connected to the active discharge resistor, the switch assembly including an active discharge switch; a signal generator; and a logic circuit electrically connected to the switch assembly and the signal generator, the logic circuit including one or more diodes and/or transistors; wherein the logic circuit is configured to selectively electrically connect the electronic controller or the signal generator to the switch assembly.

The electrical system of any preceding embodiment, wherein the active discharge switch has a voltage rating of at least 400 V.

The electrical system of any preceding embodiment, wherein the switch assembly further comprises a switch driver electrically connected to the logic circuit and the active discharge switch.

The electrical system of any preceding embodiment, further comprising a redundant power supply electrically connected to at least one of the signal generator or the switch assembly.

The electrical system of any preceding embodiment, further comprising a primary power supply electrically connected to the switch assembly.

The electrical system of any preceding embodiment, wherein the redundant power supply and the primary power supply are electrically connected to form a supplemented power supply.

The electrical system of any preceding embodiment, wherein the supplemented power supply is electrically connected to at least one of the switch assembly or the signal generator.

The electrical system of any preceding embodiment, further comprising the electrical load.

The electrical system of any preceding embodiment, wherein the active discharge resistor is electrically connected to the load.

The electrical system of any preceding embodiment, wherein the capacitance of the electrical load is at least 1 mF.

The electrical system of any preceding embodiment, wherein the active discharge system is configured to discharge the electrical load from 820 V to less than 60 V in less than 1 second.

The electrical system of any preceding embodiment, wherein the active discharge system is configured to discharge the electrical load from 820 V to less than 60 V in less than 0.5 seconds.

The electrical system of any preceding embodiment, wherein the signal generator is configured to generate a pulse having a duration corresponding to an expected discharge time of a load.

The electrical system of any preceding embodiment, wherein the signal generator includes a resistor-capacitor circuit.

The electrical system of any preceding embodiment, wherein the active discharge system is configured to discharge the electrical load via (i) the electronic controller activating the switch assembly, when the electronic controller is active, and (ii) the signal generator activating the switch assembly, when the electronic controller is inactive.

The electrical system of any preceding embodiment, wherein the active discharge system includes the electronic controller; and the electronic controller is electrically connected to the signal generator.

The electrical system of any preceding embodiment, wherein the logic circuit is configured to disable the signal generator.

The electrical system of any preceding embodiment, wherein, in response to a power source becoming inactive, the signal generator is configured to automatically generate a pulse to activate the switch assembly independently of the electronic controller.

The electrical system of any preceding embodiment, further comprising a passive discharge resistor connected in parallel with the switch assembly and the active discharge resistor.

The electrical system of any preceding embodiment, further comprising a primary power supply and a redundant power supply.

The electrical system of any preceding embodiment, wherein the signal generator is connected to the redundant power supply and configured to automatically activate the switch assembly to discharge the electrical load when the primary power supply is inactive.

The electrical system of any preceding embodiment, wherein the redundant power supply and the primary power supply are connected to form a supplemented power supply; and the signal generator is connected to the redundant power supply via the supplemented power supply.

The electrical system of any preceding embodiment, wherein the logic circuit is configured to disable the signal generator.

The electrical system of any preceding embodiment, further comprising a battery, a battery disconnect unit (BDU), and the load; wherein the BDU includes at least one contactor to selectively electrically connect the battery with the load.

The electrical system of any preceding embodiment, wherein the BDU includes the active discharge system and the electronic controller.

The electrical system of any preceding embodiment, wherein the BDU includes a passive discharge resistor.

A vehicle including the electrical system of any preceding embodiment.

The vehicle of any preceding embodiment, further comprising the electrical load.

The vehicle of any preceding embodiment, wherein the electrical load comprises an electric traction motor.

The vehicle of any preceding embodiment, wherein the electrical system further comprises a battery, and a battery disconnect unit configured to selectively electrically connect the battery with the electrical load, the battery disconnection unit including one or more contactors.

The vehicle of any preceding embodiment, wherein the electronic controller is a vehicle controller.

The vehicle of any preceding embodiment, further comprising a vehicle controller in communication with the electronic controller.

The vehicle of any preceding embodiment, wherein the vehicle controller is configured to provide a discharge signal to the electronic controller of the active discharge system.

The vehicle of any preceding embodiment, wherein the electrical system further comprises a primary power supply and a redundant power supply.

The vehicle of any preceding embodiment, wherein the vehicle controller is configured to provide a discharge signal to the electronic controller; and the electronic controller is configured, in response to receiving the discharge signal, to activate the switch assembly.

The vehicle of any preceding embodiment, wherein the signal generator is connected to the redundant power supply and configured to automatically activate the switch assembly to discharge the electrical load when at least one of the primary power supply or the electronic controller is inactive.

A method of operating the electrical system of any preceding embodiment, the method comprising: providing electrical power from a battery to a load; disconnecting the battery from the load; and discharging the load via the active discharge system.

The method of any preceding embodiment, wherein discharging the load includes the logic circuit providing a first signal from the electronic controller to the switch assembly or providing a second signal from the signal generator to the switch assembly.

The method of any preceding embodiment, further comprising determining if the electronic controller is active.

The method of any preceding embodiment, wherein the logic circuit provides the first signal to the switch assembly when the electronic controller is active; and the logic circuit provides the second signal to the switch assembly when the electronic controller is inactive.

The method of any preceding embodiment, wherein the load comprises an electric motor for driving a vehicle.

The method of any preceding embodiment, further comprising determining the electronic controller is inactive; wherein discharging the load includes the signal generator activating the switch assembly while the electronic controller is inactive.

The method of any preceding embodiment, further comprising, after determining the electronic controller is inactive, determining the electronic controller is active; and disabling the signal generator via the logic circuit while the signal generator is activating the switch assembly.

An electronic controller configured to implement the method of any preceding embodiment.

A non-transitory computer-readable storage medium having a computer program encoded thereon for implementing the method of any preceding embodiment.

A vehicle comprising the assembly of any preceding embodiment.

A vehicle comprising the electronic controller of any preceding embodiment.

A vehicle comprising the non-transitory computer-readable storage medium of any preceding embodiment.

In examples, a controller (e.g., the vehicle controller 58, the electronic controller 82) may include an electronic controller and/or include an electronic processor, such as a programmable microprocessor and/or microcontroller. In embodiments, a controller may include, for example, an application specific integrated circuit (ASIC) and/or an embedded controller. A controller may include a central processing unit (CPU), a memory (e.g., a non-transitory computer-readable storage medium), and/or an input/output (I/O) interface. A controller may be configured to perform various functions, including those described in greater detail herein, with appropriate programming instructions and/or code embodied in software, hardware, and/or other medium. In embodiments, a controller may include a plurality of controllers. In embodiments, a controller may be connected to a display, such as a touchscreen display. References to a “circuit” (e.g., the logic circuit 74) do not necessarily include complete circuits and can include one or more electrical components connected together or to other components.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “in the illustrated example,” “various embodiments,” “with embodiments,” “in embodiments,” “an embodiment,” “with some configurations,” “in some configurations,” or the like, means that a particular feature, structure, or characteristic described in connection with the example/embodiment is included in at least one embodiment. Thus, appearances of the phrases “examples, “in examples,” “with examples,” “in the illustrated example,” “in various embodiments,” “with embodiments,” “in embodiments,” “an embodiment,” “with some configurations,” “in some configurations,” or the like, in places throughout the specification are not necessarily all referring to the same embodiment. Furthermore, the particular features, structures, and/or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof. The word “exemplary” is used herein to mean “serving as a non-limiting example.”

It should be understood that references to a single element are not necessarily so limited and may include one or more of such element, unless the context clearly indicates otherwise. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above. The term “at least one of” in the context of, e.g., “at least one of A, B, and C” or “at least one of A, B, or C” includes only A, only B, only C, or any combination or subset of A, B, and C, including any combination or subset of one or a plurality of A, one or a plurality of B, and one or a plurality of C. A “set” of elements can include any number of one or more elements.

Although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise The term “and/or” as used herein refers to and encompasses any and all possible combinations of one or more of the associated listed items. Uses of “and” and “or” are to be construed broadly (e.g., to be treated as “and/or”). For example and without limitation, uses of “and” do not necessarily require all elements or features listed, and uses of “or” are inclusive unless such a construction would be illogical. The terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

References to a vehicle can include one or more of a variety of vehicles, including, without limitation, a passenger car (e.g., a sedan, a pickup truck, a sport utility vehicle, a crossover, etc.), a truck, a bus, a plane, or a boat, among others.

All matter contained in the above description or shown in the accompanying drawings shall be interpreted as illustrative only and not limiting. Changes in detail or structure may be made without departing from the present disclosure.

A controller, an electronic control unit (ECU), a system, and/or a processor as described herein may include a conventional processing apparatus known in the art, which may be capable of executing preprogrammed instructions stored in an associated memory, all performing in accordance with the functionality described herein. To the extent that the methods described herein are embodied in software, the resulting software can be stored in an associated memory and can also constitute means for performing such methods. Such a system or processor may further be of the type having ROM, RAM, RAM and ROM, and/or a combination of non-volatile and volatile memory so that any software may be stored and yet allow storage and processing of dynamically produced data and/or signals.

An article of manufacture in accordance with this disclosure may include a non-transitory computer-readable storage medium having a computer program encoded thereon for implementing logic and other functionality described herein. The computer program may include code to perform one or more of the methods disclosed herein. Such embodiments may be configured to execute via one or more processors, such as multiple processors that are integrated into a single system or are distributed over and connected together through a communications network, and the communications network may be wired and/or wireless. Code for implementing one or more of the features described in connection with one or more embodiments may, when executed by a processor, cause a plurality of transistors to change from a first state to a second state. A specific pattern of change (e.g., which transistors change state and which transistors do not), may be dictated, at least partially, by the logic and/or code.

What is claimed is:

1. An electrical system, comprising:
an electronic controller; and
an active discharge system configured to discharge an electrical load having a capacitance, the active discharge system including:
an active discharge resistor;
a switch assembly electrically connected to the active discharge resistor, the switch assembly including an active discharge switch;
a signal generator; and
a logic circuit electrically connected to the switch assembly and the signal generator, the logic circuit including one or more diodes and/or transistors;
wherein the logic circuit is configured to selectively electrically connect the electronic controller or the signal generator to the switch assembly.

2. The electrical system of claim 1, wherein the active discharge switch has a voltage rating of at least 400 V.

3. The electrical system of claim 1, wherein the switch assembly further comprises a switch driver electrically connected to the logic circuit and the active discharge switch.

4. The electrical system of claim 1, further comprising a redundant power supply electrically connected to at least one of the signal generator or the switch assembly.

5. The electrical system of claim 4, further comprising an isolated power supply electrically connected to the switch assembly.

6. The electrical system of claim 1, further comprising the electrical load.

7. The electrical system of claim 6, wherein the active discharge resistor is electrically connected to the load.

8. The electrical system of claim 6, wherein the capacitance of the electrical load is at least 1 mF.

9. The electrical system of claim 8, wherein the active discharge system is configured to discharge the electrical load from 820 V to less than 60 V in less than 1 second.

10. The electrical system of claim 8, wherein the active discharge system is configured to discharge the electrical load from 820 V to less than 60 V in less than 0.5 seconds.

11. The electrical system of claim 1, wherein the signal generator is configured to generate a pulse having a duration corresponding to an expected discharge time of a load.

12. The electrical system of claim 11, wherein the signal generator includes a resistor-capacitor circuit.

13. The electrical system of claim 1, wherein the active discharge system is configured to discharge the electrical load via (i) the electronic controller activating the switch assembly, when the electronic controller is active, and (ii) the signal generator activating the switch assembly, when the electronic controller is inactive.

14. The electrical system of claim 1, wherein the active discharge system includes the electronic controller; and
the electronic controller is electrically connected to the signal generator.

15. The electrical system of claim 14, wherein the logic circuit is configured to disable the signal generator.

16. The electrical system of claim 1, wherein, in response to a power source becoming inactive, the signal generator is configured to automatically generate a pulse to activate the switch assembly independently of the electronic controller.

17. The electrical system of claim 1, further comprising a passive discharge resistor connected in parallel with the switch assembly and the active discharge resistor.

18. The electrical system of claim 1, further comprising a primary power supply and a redundant power supply;
wherein the signal generator is connected to the redundant power supply and configured to automatically activate the switch assembly to discharge the electrical load when the primary power supply is inactive.

19. The electrical system of claim 18, wherein the logic circuit is configured to disable the signal generator.

20. The electrical system of claim 1, further comprising a battery, a battery disconnect unit (BDU), and the electrical load;
wherein the BDU includes at least one contactor to selectively electrically connect the battery with the electrical load; and
the BDU includes the active discharge system and the electronic controller.
